(19) United States
(12) Patent Application Publication
(10) Pub. No.: US 2017/0169393 A1
(43) Pub. Date: Jun. 15, 2017

(54) Method of managing user contacts and associations between the user contacts

(71) Applicant: Prakash Vasa, Millstone Township, NJ (US)

(72) Inventor: Prakash Vasa, Millstone Township, NJ (US)

(21) Appl. No.: 15/376,552

(22) Filed: Dec. 12, 2016

Related U.S. Application Data
(60) Provisional application No. 62/266,286, filed on Dec. 11, 2015.

(51) Int. Cl. G06Q 10/10

(52) U.S. Cl. CPC G06Q 10/109; G06Q 10/1095

(57) ABSTRACT

A method of managing user contacts and associations between the user contacts that employs parent accounts that are created to enable primary users to create a parent profile. Each parent account functions as the repository for the contact information for the primary user's colleagues. The method is used to determine which of the primary user's colleagues have parent accounts of their own. The method then facilitates communication between the primary user and these colleagues. In addition to organizing contact information and facilitating communication between colleagues, the method contains multiple life-management processes that the primary user is able to employ as desired.

The current application claims a priority to the U.S. Provisional Patent application Ser. No. 62/266,286 filed on Dec. 11, 2015. The current application is filed on Dec. 12, 2016 while Dec. 11, 2016 was on a weekend.

### FIELD OF THE INVENTION

The present invention relates generally to methods and systems which helps a user manage their contacts across all known contact sources. The objective of the present invention is to create a centrally managed, comprehensive personal organizer system, which includes an automated means for event suggestion, planning, and other life management tasks.

### BACKGROUND OF THE INVENTION

Present day, contact management software/hardware possesses a number of restrictions. One of the primary limiting factors in current contact management systems is that they only support one profile and can only work with one-to-one relationships. There is no hierarchical, linked tree of associations in such contact management systems. This is unrealistic, as members of society often function on a many-to-many complicated mesh of interpersonal relationships. Tasks such as sharing contact information or making appointments can get very fragmented.

In addition, sometimes data between accounts is out of date and sometimes tends to get out of synchronization due to connectivity issues or human errors during manual entry. It is therefore an objective of the present invention to introduce a device that users can utilize to overcome such problems. The present invention enables a use to manage both business and personal contact information. Additionally, the present invention enables users to manage subordinates and any important physical assets. Furthermore, the present invention functions as a communications aide and digital assistant.

### BRIEF DESCRIPTIONS OF THE DRAWINGS

FIG. 1 is a diagram illustrating how the system overview of the present invention.

FIG. 2 is a flowchart describing the overall process followed by the method of the present invention.

FIG. 3 is a flowchart describing a process of sending a join notification to the colleague contact information.

FIG. 4 is a flowchart describing a process of generating a new parent account from the response to a join notification.

FIG. 5 is a flowchart describing a process of generating a child account and specifying the permission filters for the child account.

FIG. 6 is a flowchart describing a process of generating a child account and specifying the permission filters for communication between the child account and a dependent account.

FIG. 7 is a flowchart describing a process for generating an asset entry log.

FIG. 8 is a flowchart describing a process for updating the information in an asset log entry.

FIG. 9 is a flowchart describing a process for finding an asset within the asset entry log.

FIG. 10 is a flowchart describing a process of communicating between users of the present invention.

FIG. 11 is a flowchart describing a process of sending personalized content between users of the present invention.

FIG. 12 is a flowchart describing a process of sending sharable portions of an account between users of the present invention.

FIG. 13 is a flowchart describing a process of sending personalized content from a child account to a user of the present invention.

FIG. 14 is a flowchart describing a process of sending a sharable portion from a child account to a user of the present invention.

FIG. 15 is a flowchart describing a process of selecting multiple accounts as recipients of a single message using the present invention.

FIG. 16 is a flowchart describing a process of sending personalized content from a dependent account to another user of the present invention.

FIG. 17 is a flowchart describing a process of sending personalized content from a dependent account to another user of the present invention.

FIG. 18 is a flowchart describing a process of sending sharable portions of an account between users of the present invention.

FIG. 19 is a flowchart describing a process of sending personalized content from a child account to a user of the present invention.

FIG. 20 is a flowchart describing a process of sending a sharable portion from a child account to a user of the present invention.

FIG. 21 is a flowchart describing a process of selecting multiple accounts as recipients of a single message using the present invention.

FIG. 22 is a flowchart describing a process of generating a calendar of events using the present invention.

FIG. 23 is a flowchart describing a process of notifying a user of an upcoming event using the present invention.

FIG. 23 is a flowchart describing a process of notifying a user of an upcoming event using the present invention.

FIG. 24 is a flowchart describing a process of expanding on the information about an upcoming event that is displayed using the present invention.

FIG. 25 is a flowchart describing a process of using machine learning to function as a digital assistant.

FIG. 26 is a flowchart describing a process of generating a behavioral model of a user.

### DETAIL DESCRIPTIONS OF THE INVENTION

All illustrations of the drawings are for the purpose of describing selected versions of the present invention and are not intended to limit the scope of the present invention.

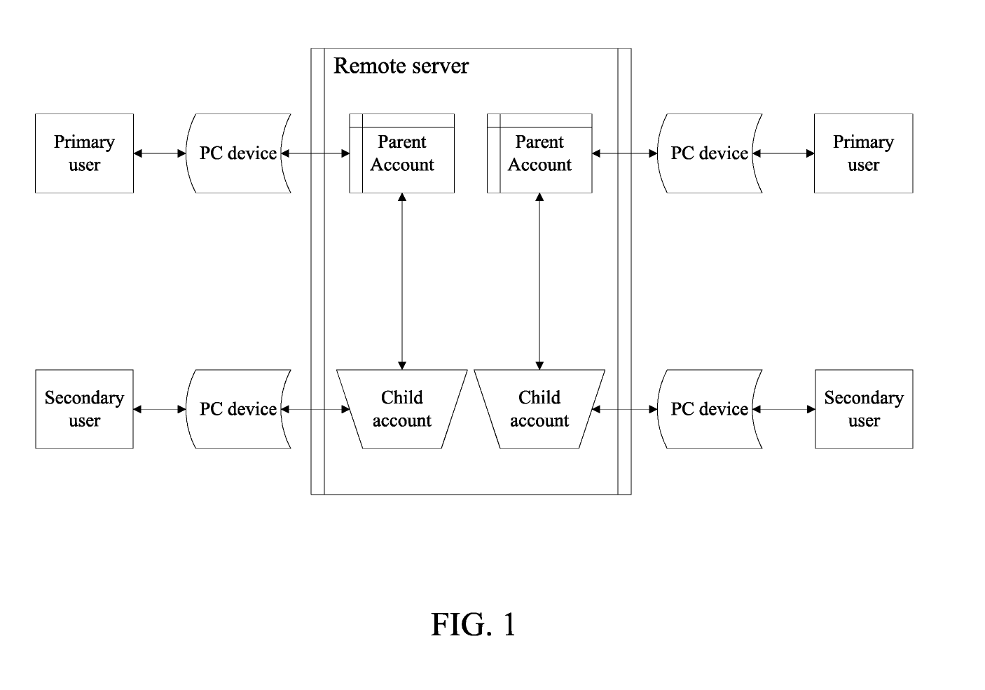

As can be seen in FIG. 1, the present invention is a method of managing user contacts and associations between the user contacts. The present invention is preferably designed as a mobile application or web-based system. The present invention enables a primary user to create digital records of the information required to contact multiple friends and colleagues. Additionally, the present invention enables the primary user to send messages to friends and colleagues who are also primary users of the present invention. The present invention also enables the primary user to make use of a hierarchical profile structure by creating subordinate accounts for secondary users. These subordinate accounts are able to communicate with each other, as well as the friends and colleagues of the primary user that created them. Another aspect of the present invention is to function as a digital assistant. This functionality enables the primary user to track personal or business assets and record calendar appointments. Furthermore, this digital assistant is designed to learn from the primary user's behavior to better anticipate the primary user's needs and desires.

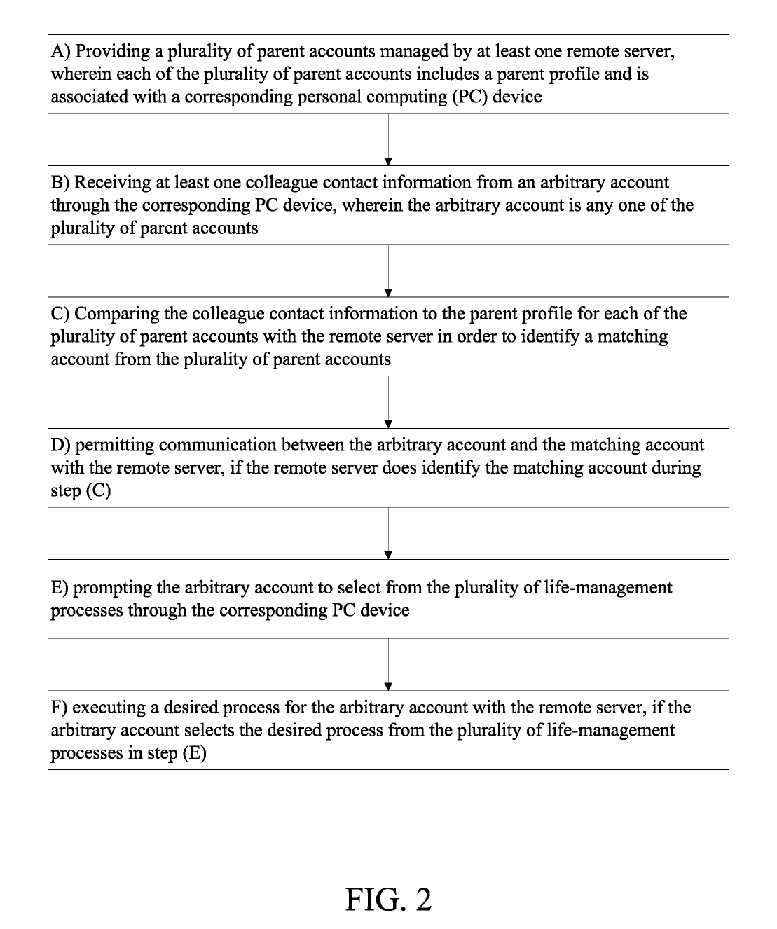

As can be seen in FIG. 1 and FIG. 2, the system used to execute the method of the present invention allows the present invention to manage the contacts for, and facilitate interactions between, a large number of users. Consequently, the present invention individually identifies each primary user with a plurality of parent accounts. A parent account allows the present invention to individually interact to each primary user. The system of the present invention includes at least one remote server to manage the plurality of parent accounts, each of which is associated to a corresponding personal computer (PC) device (Step A). The corresponding PC device is used to receive input from a primary user's and is used to relay information from the remote server to the primary user. The corresponding PC device can be, but is not limited to, a smart-phone, a laptop, a desktop, or a tablet PC. Furthermore, the remote server is used to execute a number of internal processes for the present invention and is used to store a parent profile for each of the plurality of parent accounts. The parent profile is a digital record of a primary user's information that is associated with a specific parent account and can be viewed by other primary users. The parent profile records personal information including, but not limited to, name, age, sex, phone number, physical address, email address, and occupation.

As can be seen in FIG. 2, the overall process followed by the method of the present invention allows users to manage a user's personal and business ties. The overall process begins by receiving at least one colleague contact information from an arbitrary account through the corresponding PC device (Step B). The arbitrary account is any one of the parent accounts managed by the present invention. Additionally, the colleague contact information is the information that can be used to get in contact with at least one colleague of a primary user. The present invention makes use of contact information including, but not limited to, phone numbers, email addresses, physical addresses, and screen names.

As can be seen in FIG. 2, the overall process continues by comparing the colleague contact information to the parent profile for each of the plurality of parent accounts with the remote server in order to identify a matching account from the plurality of parent accounts (Step C). This step is used to determine if the arbitrary account has colleagues who are already using the present invention to manage personal and business ties. Accordingly, the matching account is a parent account that contains contact information that matches the colleague contact information supplied by the arbitrary account.

As can be seen in FIG. 2, once the comparison between colleague contact information and the plurality of parent accounts is complete, the overall process continues by permitting communication between the arbitrary account and the matching account with the remote server, if the remote server does identify the matching account during Step C (Step D). The present invention enables the arbitrary account to send and receive information to the matching account. This information includes, but is not limited to, messages, profile information, calendar appointments, location information, and colleague contact information.

As can be seen in FIG. 2, the overall process continues by prompting the arbitrary account to select from the plurality of life-management processes through the corresponding PC device (Step E). The plurality of life-management processes is a collection of routines that enable the arbitrary account to execute functions that include, but are not limited to, creating subordinate profiles, creating calendar events, communicating between accounts, managing assets, and employing a digital assistant. The overall process concludes by executing a desired process for the arbitrary account with the remote server, if the arbitrary account selects the desired process from the plurality of life-management processes in Step E (Step F). The desired process is one of the life-management processes that the primary user wants to perform.

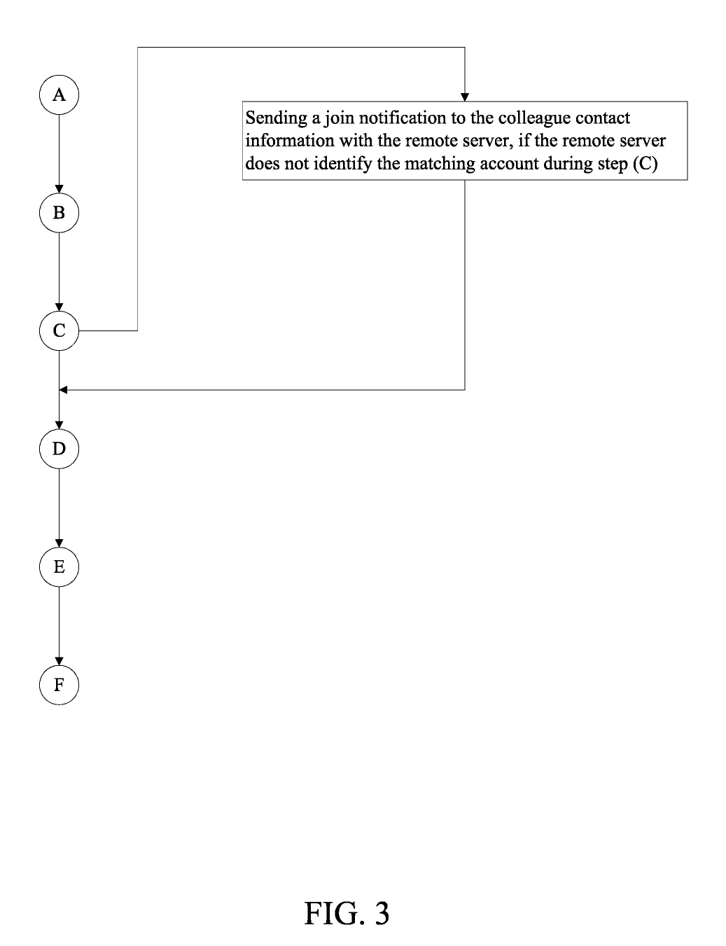

As can be seen in FIG. 3, one variation of the overall process is the ability to send a join notification to the colleague contact information with the remote server, if the remote server does not identify the matching account during Step C. The join notification is a message that is sent to individuals who are included in the colleague contact information which is supplied by the arbitrary account. This join notification could be sent in formats including, but not limited to, emails and text messages. In the present invention, the join notification is associated with the arbitrary account and contains forms which an individual may complete to create a parent account. Once the join notification has been sent, the recipient can fill out the included form and transmit a response to the remote server.

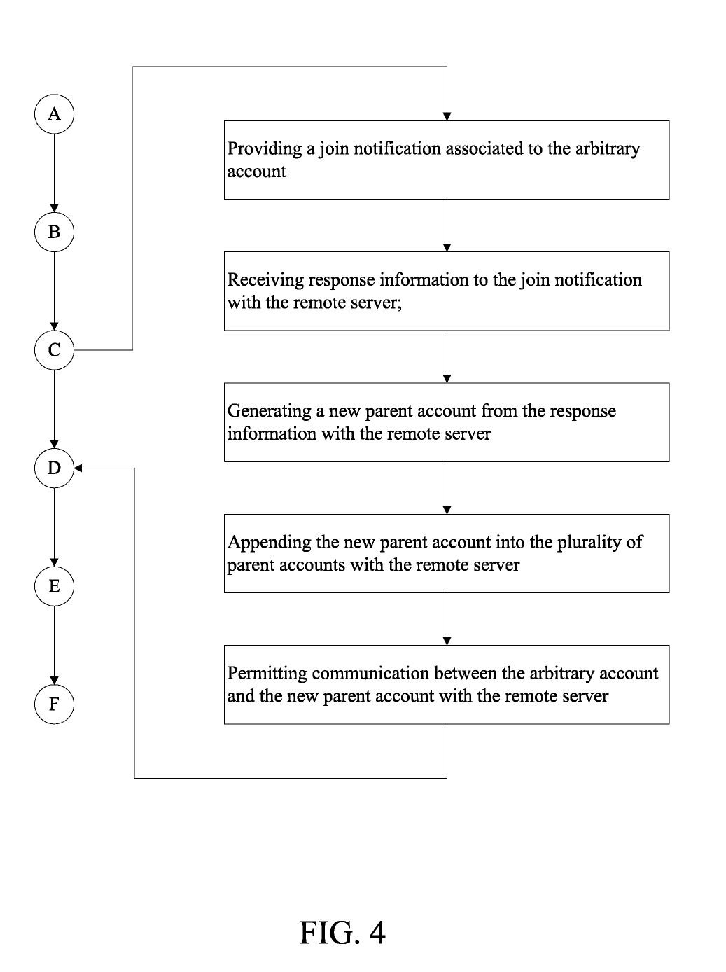

As can be seen in FIG. 3 and FIG. 4, the present invention then receives the response information for the join notification with the remote server. The response information contains the information that is required for the remote server to create a parent account for the responder. The present invention then generates a new parent account from the response information with the remote server. The responder is given the credentials required to access the present invention. The present invention then appends the new parent account into the plurality of parent accounts with the remote server. The remote server is now ready to allocate the necessary resources to handle any requests made by the new parent account through a corresponding PC device. The responder now has access to the present invention's contact management systems and can employ the life-management processes as desired. The present invention then permits communication between the arbitrary account and the new parent account with the remote server. As a result, the arbitrary account is automatically appended to the new parent account's list of colleague contact information. Similarly, the new parent account is automatically appended to the arbitrary account's list of colleague contact information. This enables the arbitrary account and the parent account to begin sending messages and sharing various types of information to each other.

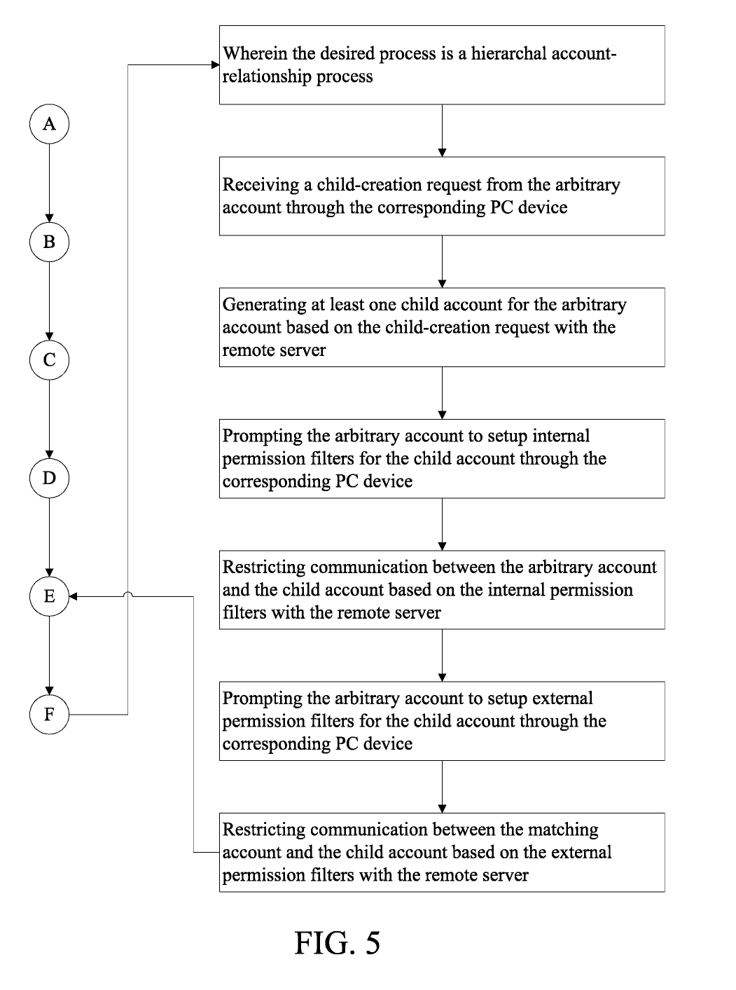

As can be seen in FIG. 5, a sub-process of the method of the present invention enables an arbitrary account to create at least one child account for secondary users. The child account is directly managed by the arbitrary account through a hierarchal account-relationship process. This sub-process is initiated when the arbitrary account selects the hierarchal account-relationship process as the desired process from the plurality of life-management processes. The sub-process continues when the present invention receives a child-creation request from the arbitrary account through the corresponding PC device.

The child-creation request is a command that directs the remote server to create a child account that is associated with the arbitrary account. Additionally, the child-creation request contains the information required to associate at least one child account with at least one specific secondary user.

As can be seen in FIG. 5, the sub-process continues by generating at least one child account for the arbitrary account based on the child-creation request with the remote server. The remote server is now ready to allocate the necessary resources to handle any requests made by the new child account through a corresponding PC device. The sub-process continues by prompting the arbitrary account to setup internal permission filters for the child account through the corresponding PC device. The internal permission filters are a collection of settings that the arbitrary account applies to the child account to dictate the information that is shared between the parent account and the child account. For example, the internal permission filters dictate whether the child account has access to all the arbitrary account's calendar events and colleague contact information. The sub-process concludes by restricting communication between the arbitrary account and the child account based on the internal permission filters with the remote server. The remote server then implements the restrictions dictated by the internal permission filters.

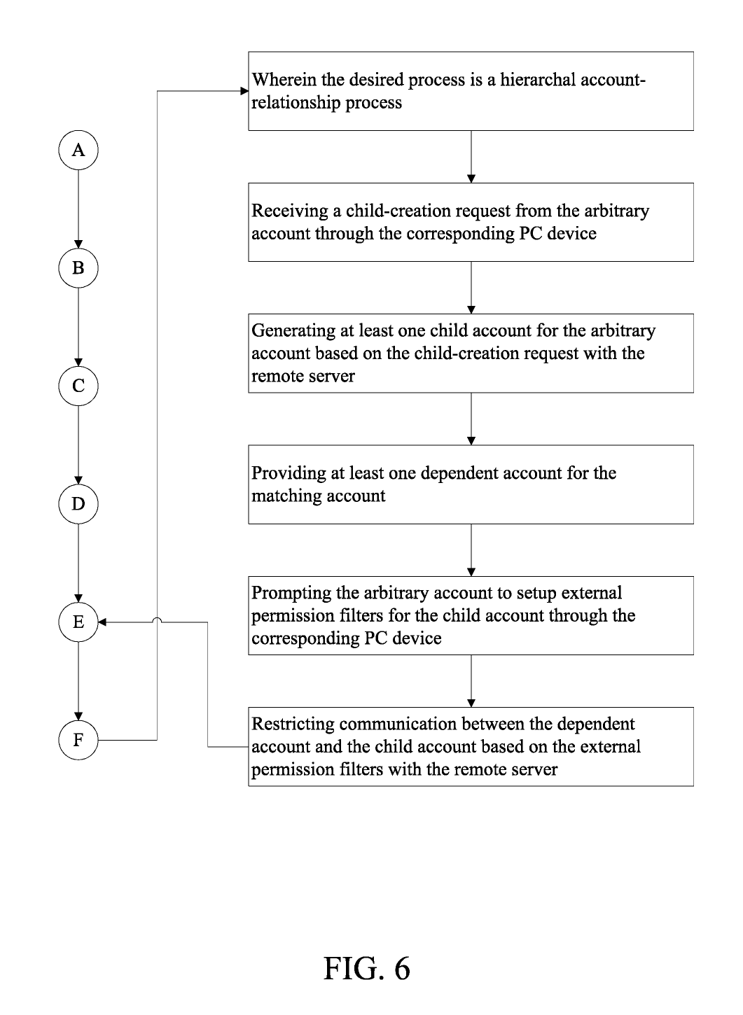

As can be seen in FIG. 5, and FIG. 6, in addition, the hierarchal account-relationship process enables a primary user to define how managed subordinate accounts can communicate with primary users with whom the subordinate account is not directly affiliated. To that end, the sub-process continues by prompting the arbitrary account to set up external permission filters for the child account through the corresponding PC device. The external permission filters are a collection of settings that the arbitrary account applies to the child account to dictate the information that is shared between the child account and the matching account. For example, the external permission filters dictate whether the matching account has access to all the child account's calendar events and the information about the specific secondary user for whom the child account was created. Additionally, the external permission filters determine if the child account and the matching account can exchange messages. The sub-process concludes by restricting communication between the matching account and the child account based on the external permission filters with the remote server. The remote server then implements the restrictions dictated by the external permission filters.

As can be seen in FIG. 5 and FIG. 6, furthermore, the hierarchal account-relationship process enables a primary user to define how managed subordinate accounts can communicate with subordinate accounts that are managed by other primary users. This functionality is only feasible providing there is at least one dependent account for the matching account. The dependent account is a subordinate account that has been created by the matching account. More specifically, the dependent account is the subordinate account for a secondary user who is being managed by a colleague's primary account, rather than the child account being managed by the primary user who is defining the external permission filters. To that end, the sub-process continues by prompting the arbitrary account to set up external permission filters for the child account through the corresponding PC device. In this instance, the external permission filters are a collection of settings that the arbitrary account applies to the child account to dictate the information that is shared between the child account and the dependent account. The external permission filters dictate whether the dependent account has access to all the child account's calendar events and the information about the specific secondary user for whom the child account was created. Additionally, external permission filters determine if the child account and the dependent account can exchange messages. For example, the foremen of two separate construction teams can limit or restrict the ability of their workers to communicate with each other through the present invention. The sub-process concludes by restricting communication between the dependent account and the child account based on the external permission filters with the remote server. The remote server then implements the restrictions dictated by the external permission filters.

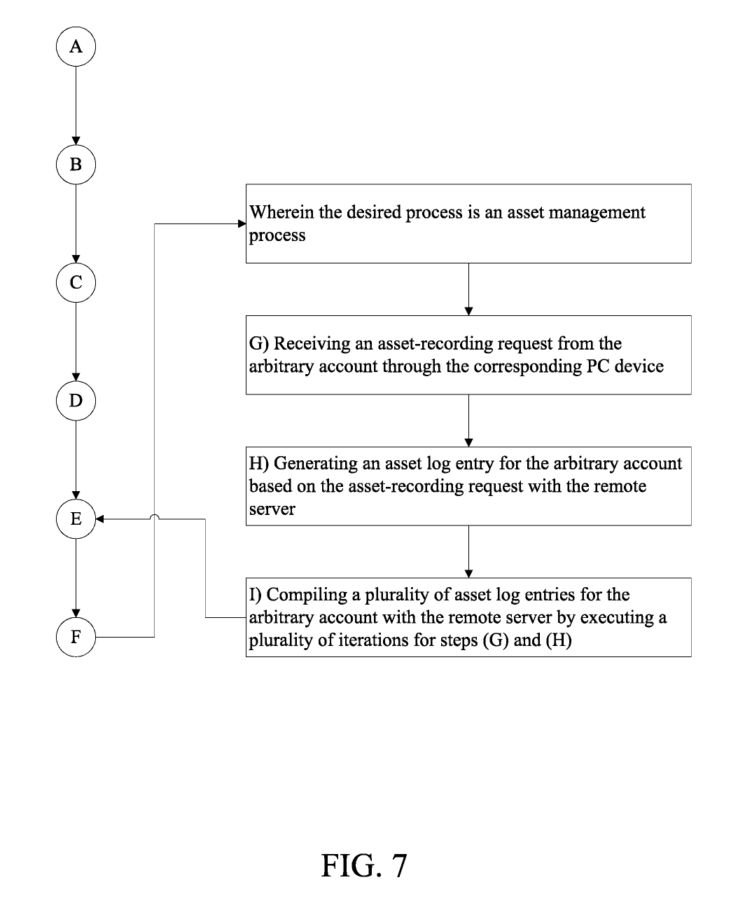

As can be seen in FIG. 7, a separate sub-process of the method of the present invention enables an arbitrary account to create and manage a list of assets that are associated with the arbitrary account. These assets can include, but are not limited to, printers, vehicles, appliances, computers, and phones. This sub-process enables a primary user to record information about assets that includes, but is not limited to, physical location, maintenance records, receipts, and warranties. This sub-process is initiated by the arbitrary account selecting an asset management process from the plurality of life-management processes. The sub-process continues by receiving an asset-recording request from the arbitrary account through the corresponding PC device (Step G). The asset-recording request is a command that the primary user issues to direct the present invention to create a record for at least one new asset. Additionally, the asset-recording request contains the information which the primary user would like to have recorded by the present invention. The sub-process continues by generating an asset log entry for the arbitrary account based on the asset recording request with the remote server (Step H). The asset log entry is a digital record of the information the primary user included in the asset-recording request. This digital record is stored in the remote server. The sub-process concludes by compiling a plurality of asset log entries from the arbitrary account with the remote server by executing a plurality of iterations for Step G and Step H (Step I). This enables the primary user to add a plurality of asset log entries to the asset entry log being compiled by the remote server.

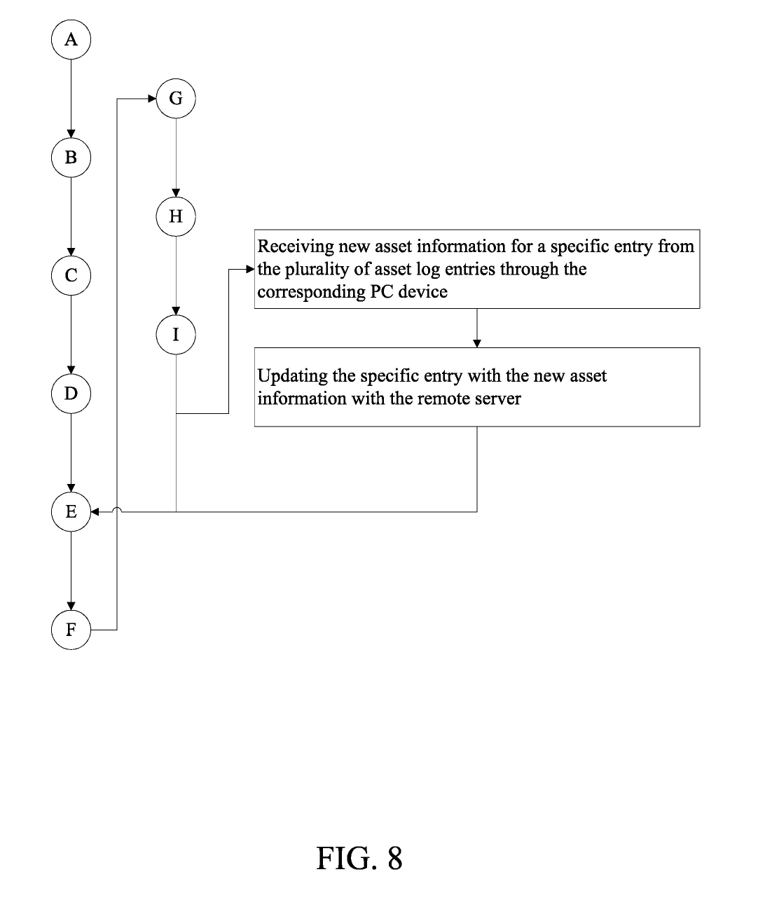

As can be seen in FIG. 8, in addition to adding asset log entries to the asset entry log, the asset management process enables the primary user to update the information contained within specific asset log entries. To accomplish this, the sub-process begins by receiving new asset information for a specific entry from the plurality of asset log entries through the corresponding PC device. The new asset information contains the information that will be updated within an existing entry of the asset entry log. The sub-process concludes by updating the specific entry with the new asset information with the remote server. The remote server now contains the updated information for the asset.

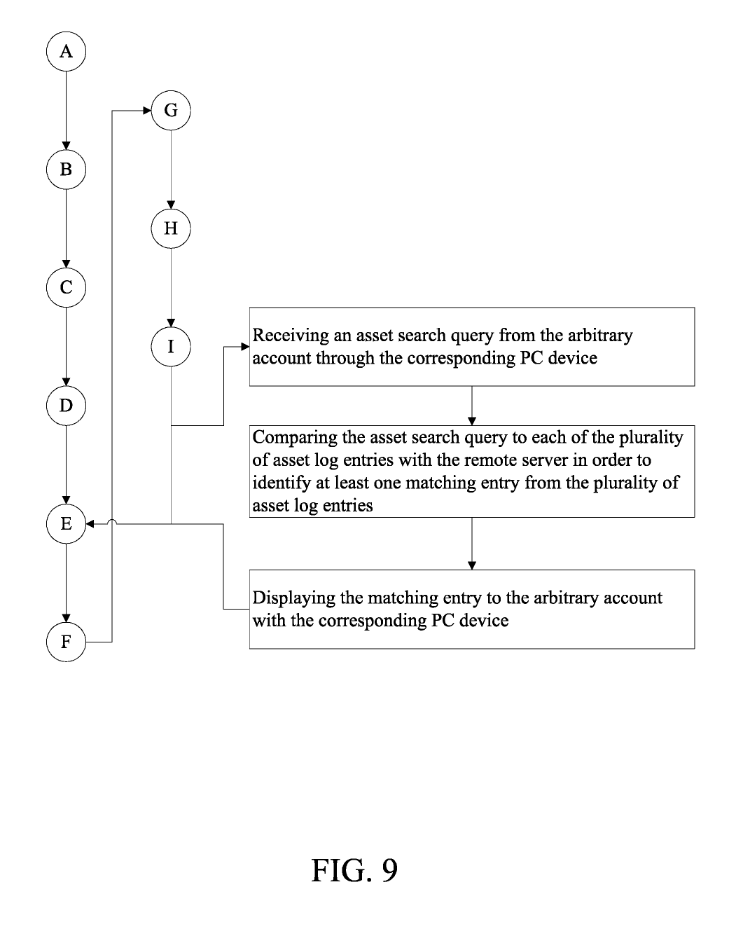

As can be seen in FIG. 9, the asset management process also enables the primary user to search for specific assets within the asset entry log. This functionality is initiated by receiving an asset search request from the arbitrary account through the corresponding PC device. The asset search query contains information, such as keywords, and the like, that can be used to locate specific asset log entries within the asset entry log. The sub-process continues by comparing the asset search query to each of the plurality of asset log entries with the remote server in order to identify at least one matching entry from the plurality of asset log entries. Accordingly, the remote server performs a search operation to find the specific asset log entries that match the information supplied in the asset search query. Finally, the sub-process concludes by displaying the matching entry to the arbitrary account with the corresponding PC device. The primary user is then able to view the results of the asset search query and select the desired asset log entry or submit a new asset search query.

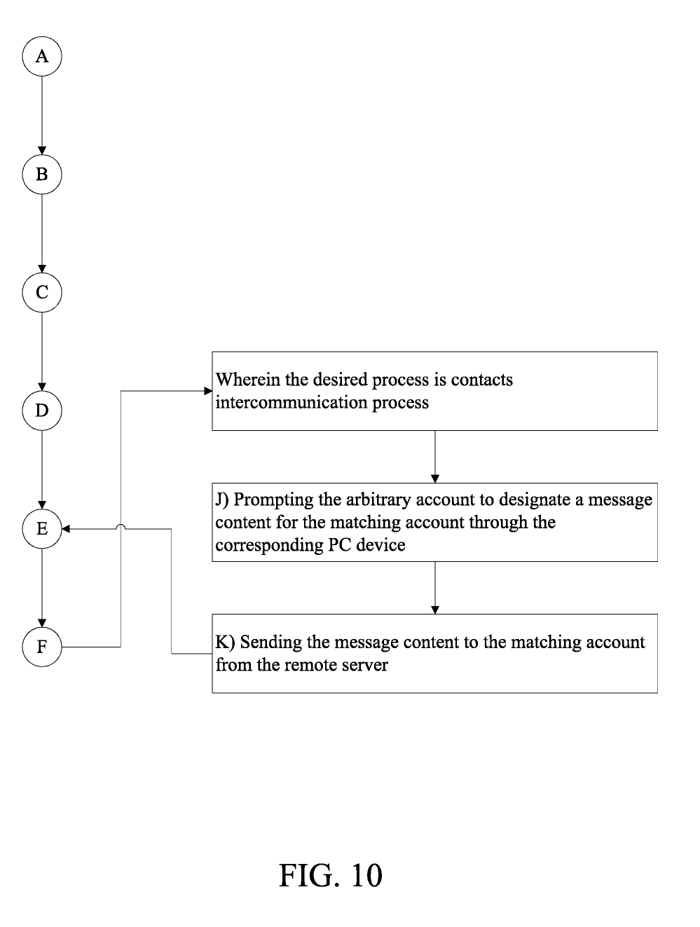

As can be seen in FIG. 10, a separate sub-process of the method of the present invention enables primary users and secondary users to send and receive messages. The primary user is enabled to interact with other users by selecting a contacts intercommunication process from the plurality of life-management processes. This sub-process is initiated by prompting the arbitrary account to designate a message content for the matching account through the corresponding PC device (Step J). The message content includes, but is not limited to, pictures, personal messages, multimedia content, calendar appointments, and account data. Additionally, the arbitrary account specifies the matching account that is intended to receive the designated message content. The sub-process concludes by sending the message content to the matching account from the remote server (Step K) so that once the arbitrary account has specified the message content and chosen a desired recipient, the remote server transfers the message content to the desired recipient.

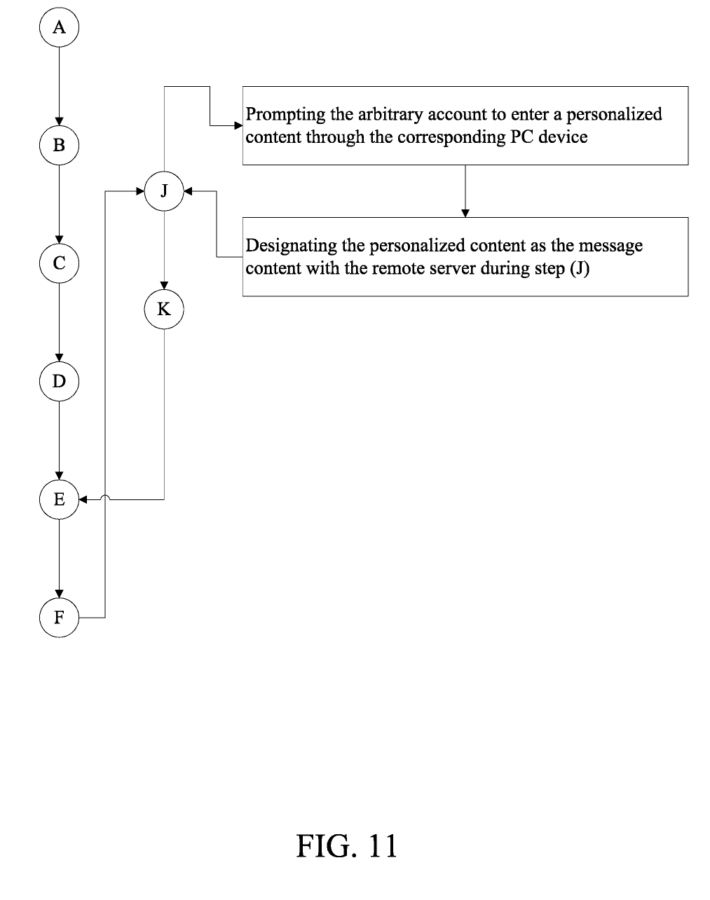

As can be seen in FIG. 11, a more specialized sub-process of the contacts intercommunication process grants primary users the ability to transmit and receive personalized content. This sub-process begins by prompting the arbitrary account to enter a personalized content through the corresponding PC device. The personalized content is a user defined selection of data that can include, but is not limited to, pictures, multimedia content, audio files, GIFs, and hand drawn sketches. The sub-process concludes by designating the personalized content as the message content with the remote server during Step J. The remote server then transmits the message content as described above.

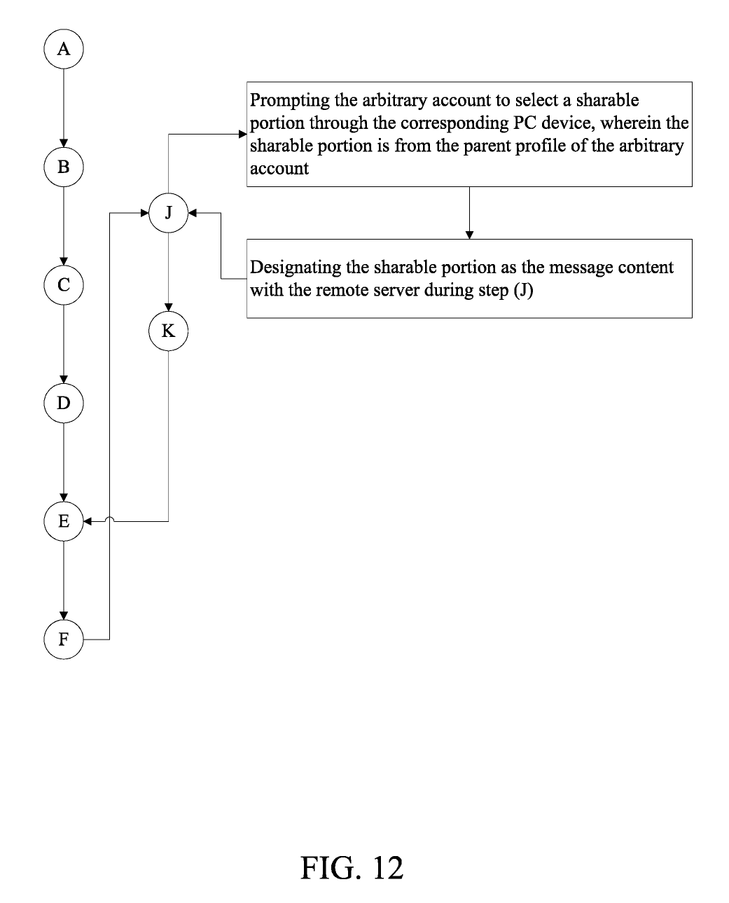

As can be seen in FIG. 12, another specialized sub-process of the contacts intercommunication process grants primary users the ability to transmit and receive portions of their profiles. This sub-process begins by prompting the arbitrary account to select a sharable portion through the corresponding PC device. The sharable portion is a selection of information that is gathered from the parent profile of the primary user. The sub-process concludes by designating the sharable portion as the message content with the remote server during Step J. The remote server then transmits the message content as described above.

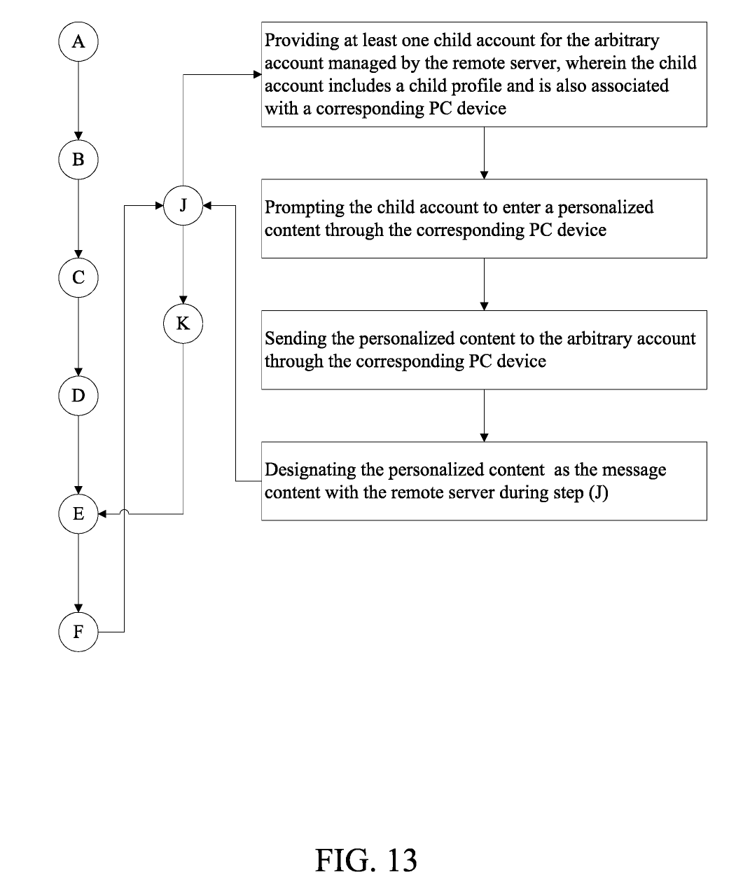

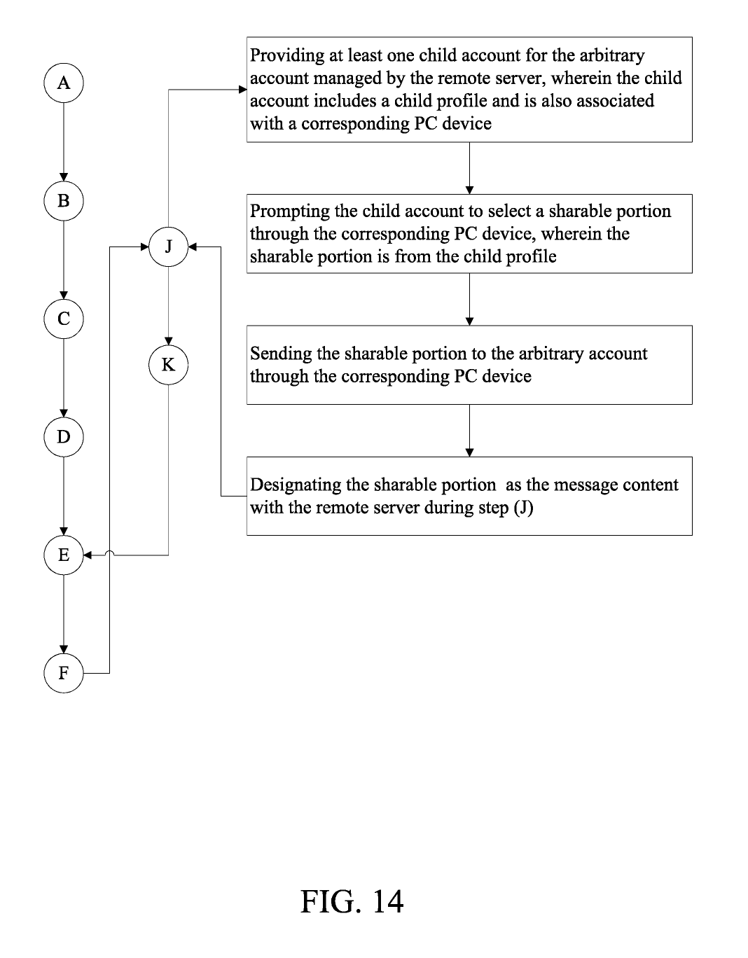

As can be seen in FIG. 13, yet another specialized sub-process of the contacts intercommunication process grants secondary users the ability to transmit and receive personalized content. In this sub-process, at least one child account is tied to the arbitrary account that is managed by the remote server. Additionally, each child account includes a child profile and is also associated with a corresponding PC device. The child profile contains information about the secondary user for whom the child account was created. This sub-process begins by prompting the child account to enter a personalized content through the corresponding PC device. The personalized content is a user-defined selection of data that can include, but is not limited to, pictures, multimedia content, audio files, Graphics interchange format filed (GIFs), and hand drawn sketches. The sub-process continues by sending the personalized content to the arbitrary account through the corresponding PC device. This step enables the primary user to actively monitor the information that is transmitted or received by the child account. As a result, the parent account functions as the mediator for communication with the child account and the has the ability to deny transmission of unwanted message content. The sub-process concludes by designating the personalized content as the message content with the remote server during Step J. The remote server then transmits the message content as described above. As can be seen in FIG. 14, in a sub-process similar to the process used to transmit a personalized content from a child account, the contacts intercommunication process grants secondary users the ability to transmit and receive sharable portions of their profiles. This sub-process begins by prompting the child account to select a sharable portion through the corresponding PC device. The sharable portion is a selection of information that is gathered from the child profile of the secondary user. The sub-process continues by sending the sharable portion to the arbitrary account through the corresponding PC device. This step enables the primary user to actively monitor the information that is transmitted or received by the child account. As a result, the parent account functions as the mediator for communication with the child account and has the ability to deny transmission of unwanted message content. The sub-process concludes by designating the sharable portion as the message content with the remote server during Step J. The remote server then transmits the message content as described above.

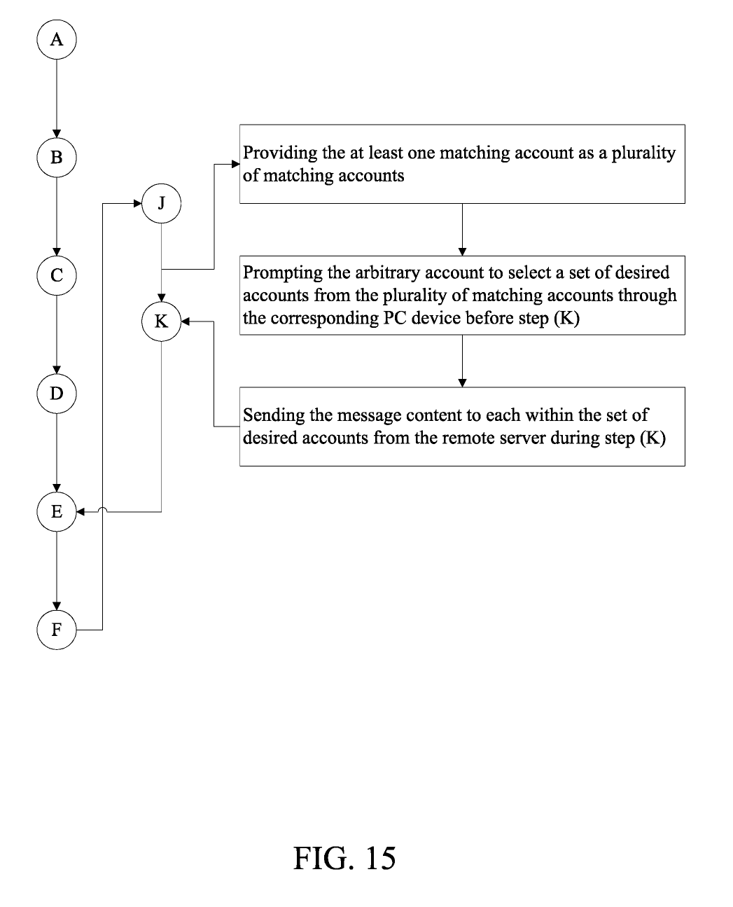

As can be seen in FIG. 15, to expound on the steps of the contacts intercommunication process, the method of the present invention makes use of a sub-process that enables the primary user to select at least one recipient for a desired message content from a plurality of possible message recipients. This sub-process begins by prompting the arbitrary account to select a set of desired accounts from a plurality of matching accounts through the corresponding PC device before Step K. The plurality of desired accounts is the plurality of possible message recipients. Once the set of desired accounts is selected, the sub-process concludes by sending the message content to each account within the set of desired accounts from the remote server during Step K. The remote server then transmits the message content as described above.

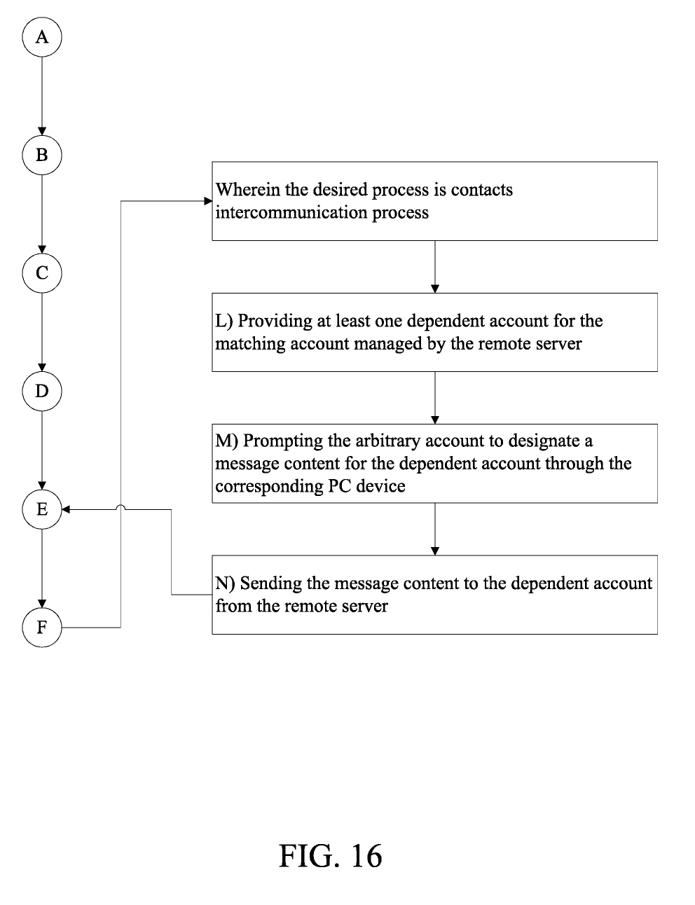

As can be seen in FIG. 16, a separate sub-process of the method of the present invention enables matching accounts and their associated secondary users to send and receive messages. The matching account is enabled to interact with other users by selecting a contacts intercommunication process from the plurality of life-management processes. The present invention provides at least one dependent account for the matching account managed by the remote server (Step L). The dependent account is an account that is created for a specific secondary user of the matching account. This sub-process is initiated by prompting the arbitrary account to designate a message content for the dependent account through the corresponding PC device (Step M). The message content includes, but is not limited to, pictures, personal messages, multimedia content, calendar appointments, and account data. Additionally, the arbitrary account specifies the dependent account that is intended to receive the designated message content. The sub-process concludes by sending the message content to the dependent account from the remote server (Step N). Once the arbitrary account has specified the message content and chosen a desired recipient, the remote server transfers the message content to the desired recipient.

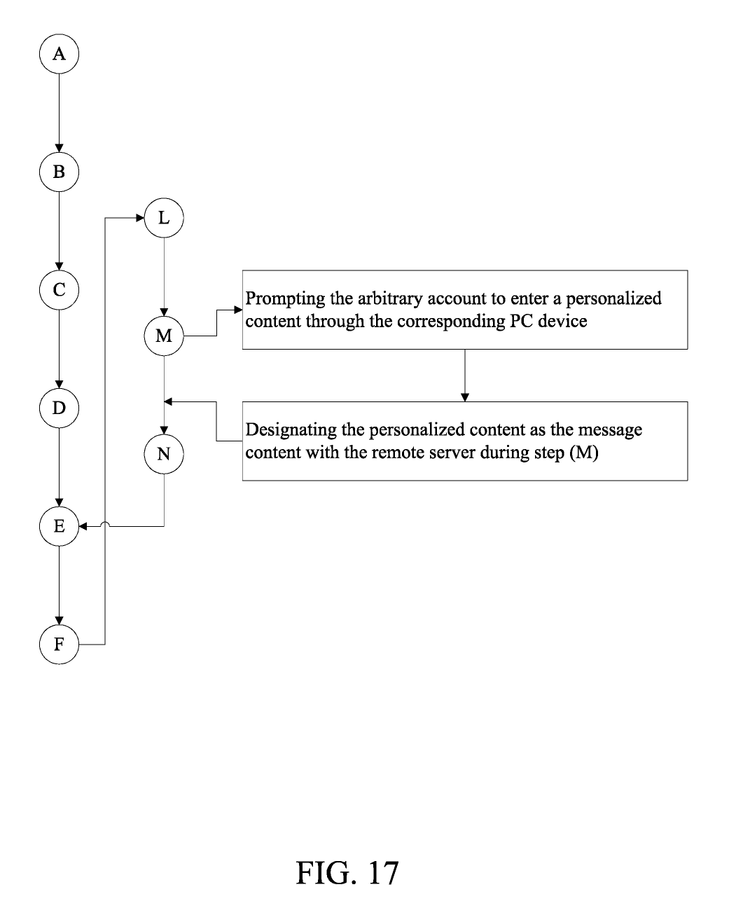

As can be seen in FIG. 17, a more specialized sub-process of the contacts intercommunication process grants primary users the ability to transmit and receive personalized content. This sub-process begins by prompting the arbitrary account to enter a personalized content through the corresponding PC device. The personalized content is a user-defined selection of data that can include, but is not limited to, pictures, multimedia content, audio files, GIFs, and hand drawn sketches. The sub-process concludes by designating the personalized content as the message content with the remote server during Step M. The remote server then transmits the message content as described above.

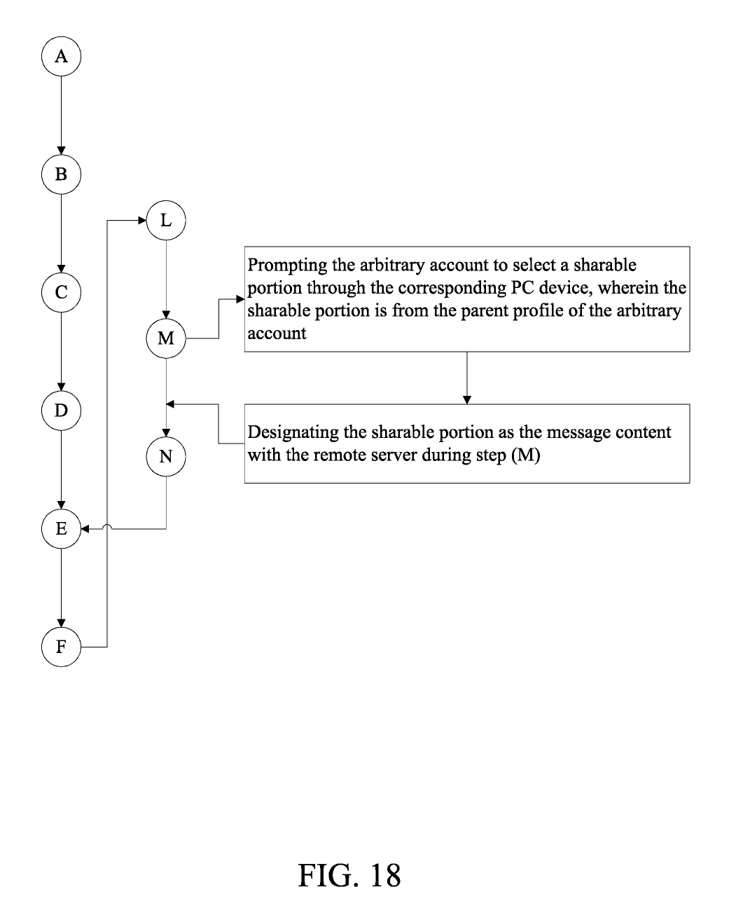

As can be seen in FIG. 18, another specialized sub-process of the contacts intercommunication process grants primary users the ability to transmit and receive portions of their profiles. This sub-process begins by prompting the arbitrary account to select a sharable portion through the corresponding PC device. The sharable portion is a selection of information that is gathered from the parent profile of the primary user. The sub-process concludes by designating the sharable portion as the message content with the remote server during Step M. The remote server then transmits the message content as described above.

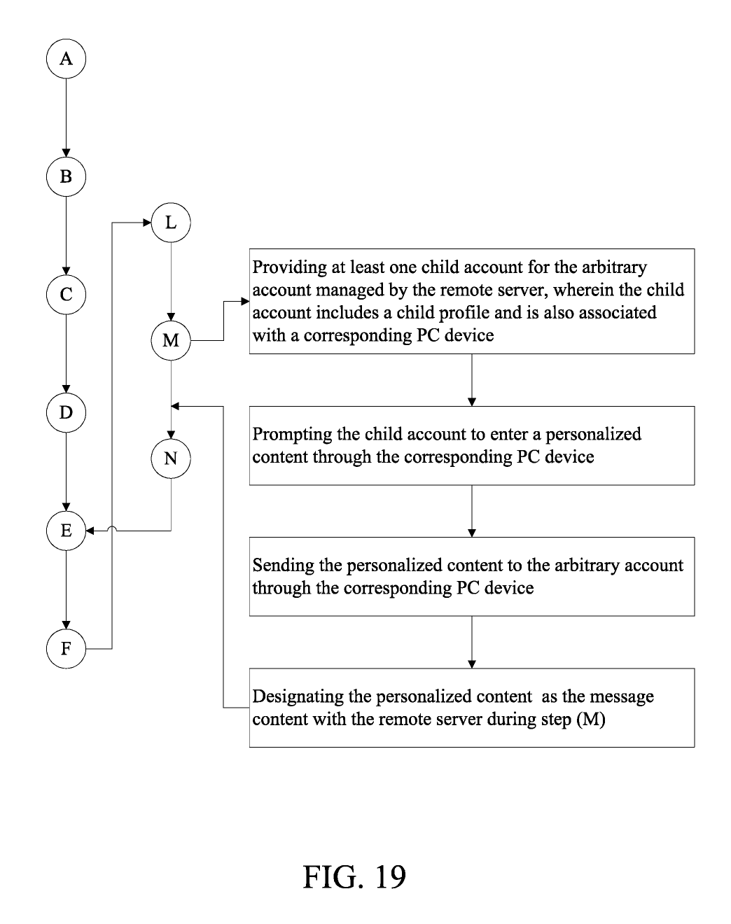

As can be seen in FIG. 19, yet another specialized sub-process of the contacts intercommunication process grants secondary users with the ability to transmit and receive personalized content. In this sub-process, at least one child account is tied to the arbitrary account that is managed by the remote server. Additionally, each child account includes a child profile and is also associated with a corresponding PC device. The child profile contains information about the secondary user for whom the child account was created. This sub-process begins by prompting the child account to enter a personalized content through the corresponding PC device. The personalized content is a user-defined selection of data that can include, but is not limited to, pictures, multimedia content, audio files, GIFs, and hand drawn sketches. The sub-process continues by sending the personalized content to the arbitrary account through the corresponding PC device. This step enables the primary user to actively monitor the information that is transmitted or received by the child account. As a result, the parent account functions as the mediator for communication with the child account and has the ability to deny transmission of unwanted message content. The sub-process concludes by designating the personalized content as the message content with the remote server during Step M. The remote server then transmits the message content as described above.

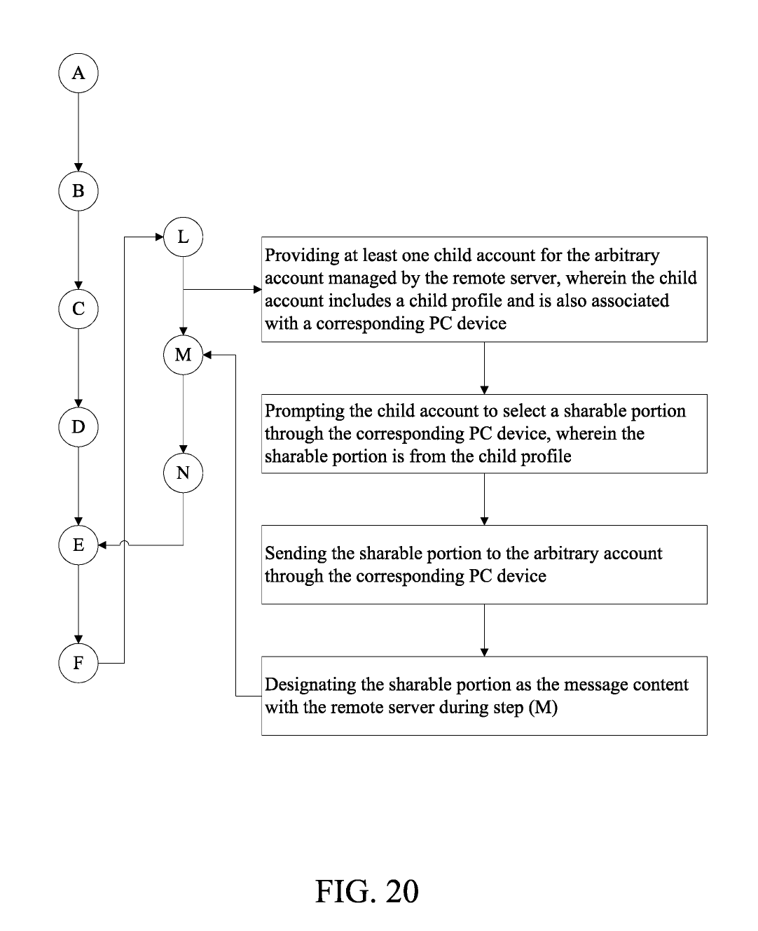

As can be seen in FIG. 20, in a sub-process similar to the process used to transmit a personalized content from a child account, the contacts intercommunication process grants secondary users the ability to transmit and receive sharable portions of their profiles. This sub-process begins by prompting the child account to select a sharable portion through the corresponding PC device. The sharable portion is a selection of information that is gathered from the child profile of the secondary user. The sub-process continues by sending the sharable portion to the arbitrary account through the corresponding PC device. This step enables the primary user to actively monitor the information that is transmitted or received by the child account. As a result, the parent account functions as the mediator for communication with the child account and the has the ability to deny transmission of unwanted message content. The sub-process concludes by designating the sharable portion as the message content with the remote server during Step M. The remote server then transmits the message content as described above.

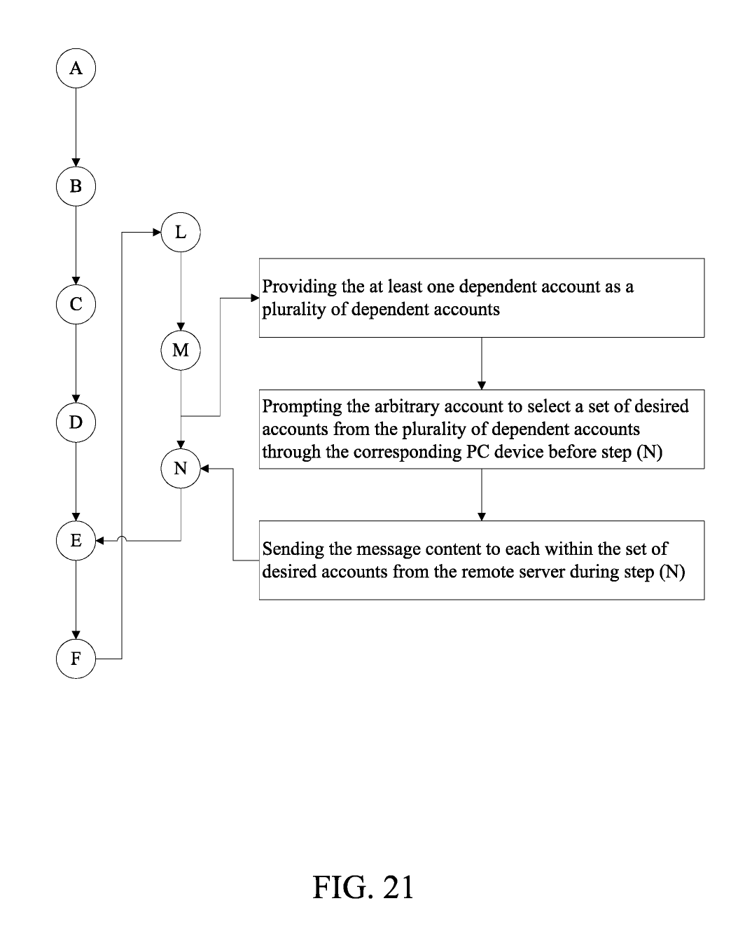

As can be seen in FIG. 21, to expound on the steps of the contacts intercommunication process, the method of the present invention makes use of a sub-process that enables the primary user to select at least one recipient for a desired message content from a plurality of possible message recipients. This sub-process begins by prompting the arbitrary account to select a set of desired accounts from a plurality of matching accounts through the corresponding PC device before Step K. The plurality of desired accounts is the plurality of possible message recipients. Once the set of desired accounts is selected, the sub-process concludes by sending the message content to each account within the set of desired accounts from the remote server during Step N. The remote server then transmits the message content as described above.

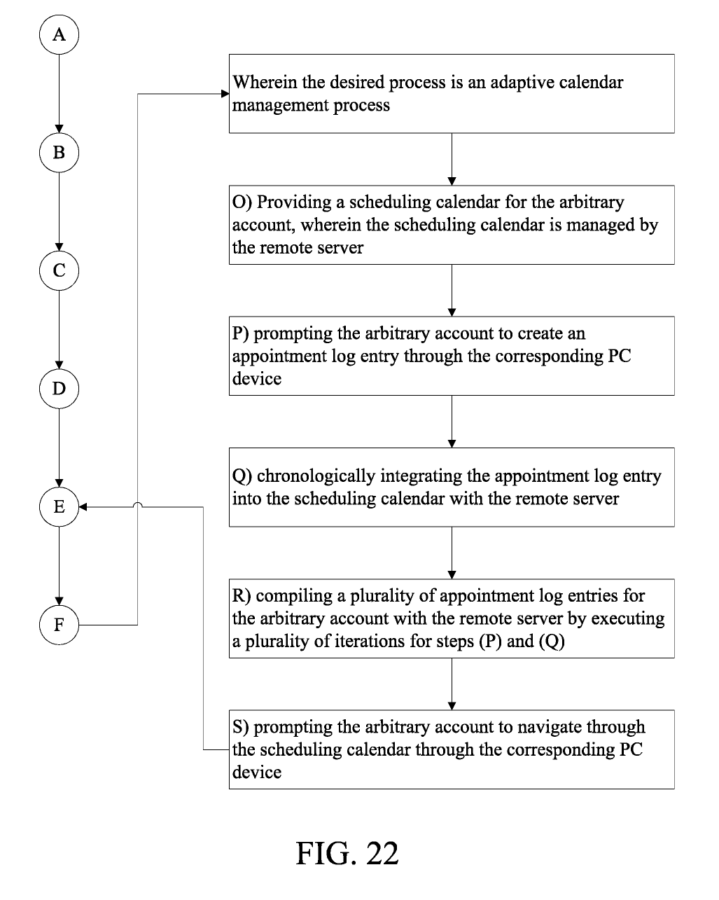

As can be seen in FIG. 22, t separate sub-process of the method of the present invention enables primary users to manage the events on a digital calendar. The primary user is enabled to schedule future events for themselves as and associated secondary users by selecting an adaptive calendar management process from the plurality of life-management processes. The present invention provides a scheduling calendar for the arbitrary account (Step O). The scheduling calendar functions as a digital calendar to which the primary user is able to add, remove, and modify upcoming events. Additionally, the scheduling calendar is managed by the remote server. This sub-process is initiated by prompting the arbitrary account to create an appointment log entry through the corresponding PC device (Step P). The appointment log entry is an upcoming event that the primary user wants to be added to the digital calendar. This appointment log entry can include, but is not limited to, the time, the date, the location, and an alarm. The sub-process continues by chronologically integrating the appointment log entry into the scheduling calendar with the remote server (Step Q). As a result, the remote server adds the upcoming event to the primary user's digital calendar. The sub-process continues by compiling a plurality of appointment log entries for the arbitrary account with the remote server by executing a plurality of iterations for Step P and Step Q (Step R). By running multiple iterations of Step P and Step Q, the present invention enables the primary user to add a plurality of future events to the digital calendar. The Sub-process concludes by prompting the arbitrary account to navigate through the scheduling calendar through the corresponding PC device. Once the primary user has added the desired future events to the digital calendar, the present invention enables the primary user to view the future events in a cohesive graphical interface.

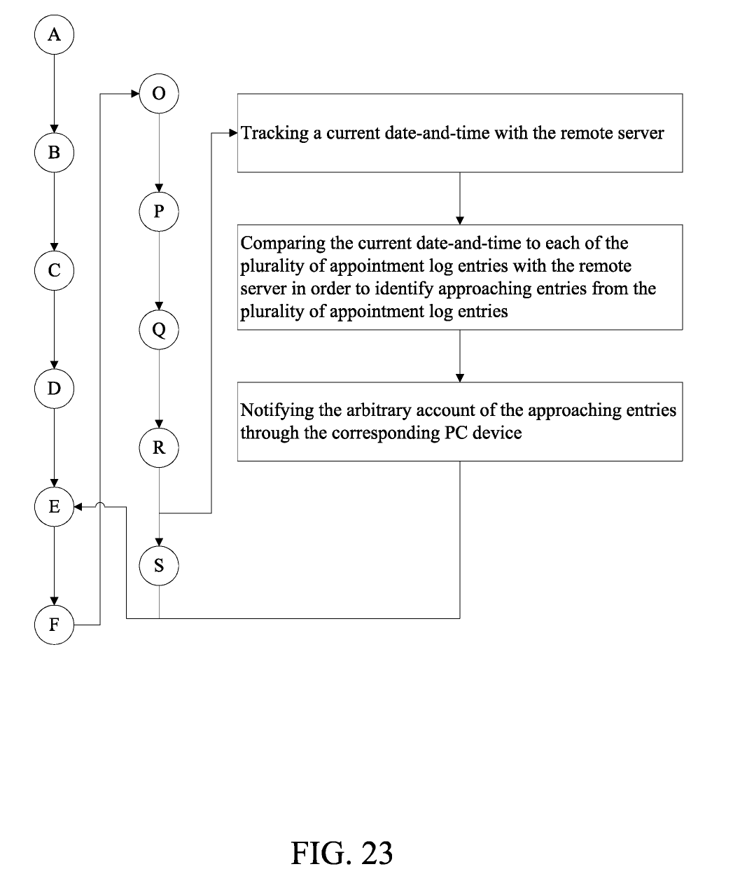

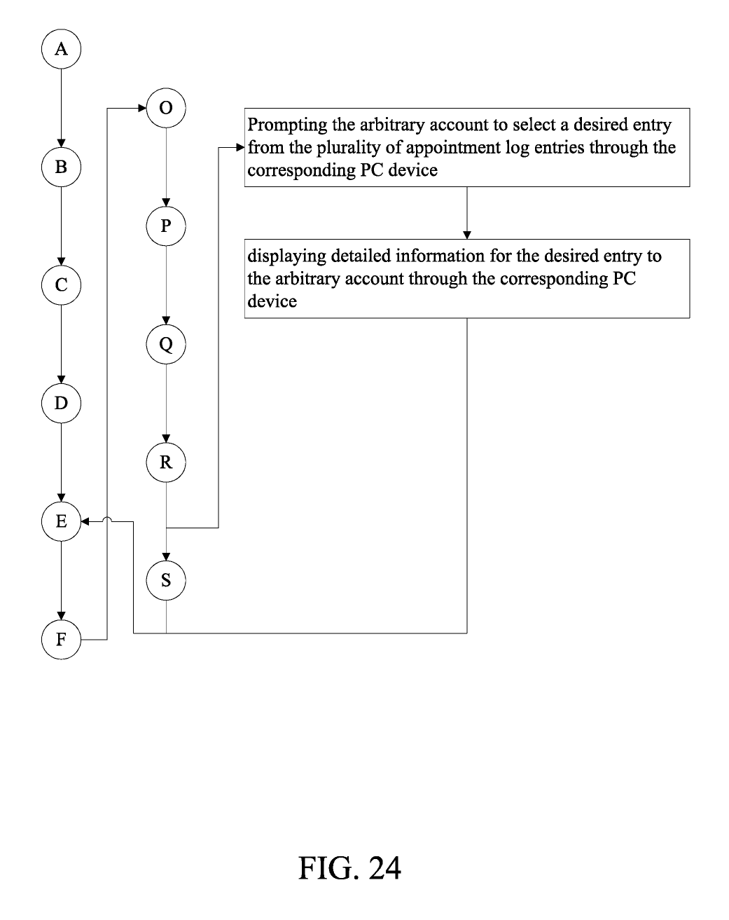

As can be seen in FIG. 23 and FIG. 24, a more specialized sub-process of the adaptive calendar management process notifies primary users of upcoming future events. This sub-process begins by comparing the current date-and-time to each of the plurality of appointment log entries with the remote server in order to identify approaching entries from the plurality of appointment log entries. The present invention makes use of user-defined thresholds to determine when an alert for an upcoming event should be transmitted to the primary user. The sub-process concludes by notifying the arbitrary account of the approaching entries through the corresponding PC device. This alert is used to keep the primary user abreast of upcoming events. Another specialized sub-process of the adaptive calendar management process enables the primary user to modify the level of detail displayed through the graphical interface. This sub-process begins by prompting the arbitrary account to select a desired entry from the plurality of appointment log entries through the corresponding PC device. This enables the primary user to choose the future event about which more detailed information is desired. The sub-process concludes by displaying detailed information for the desired entry to the arbitrary account through the corresponding PC device. The primary user is able to choose the format and modify the type of information displayed through the graphical interface.

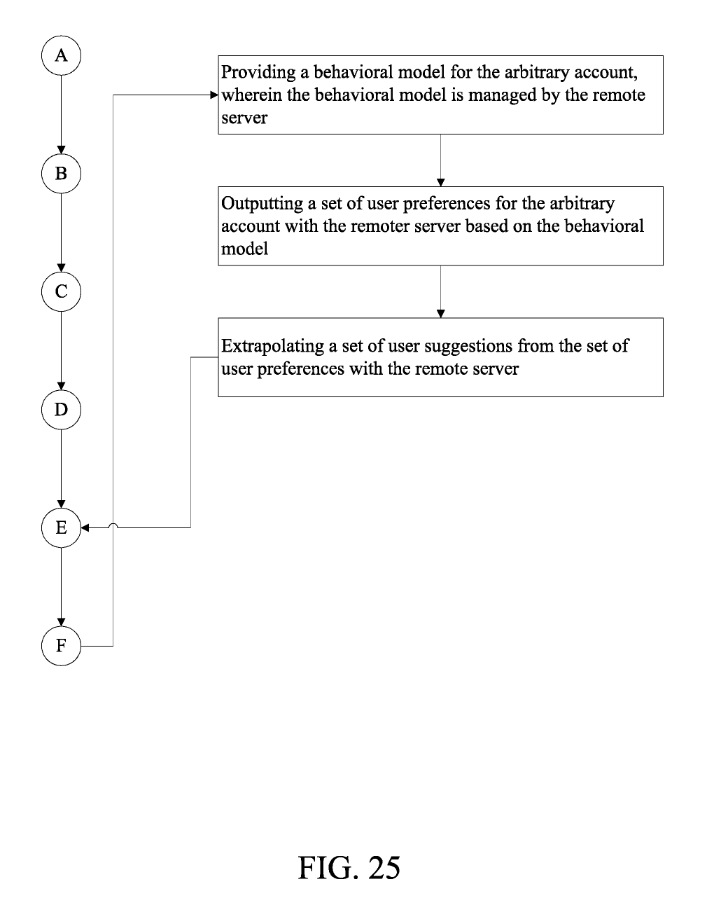

As can be seen in FIG. 25, a feature of the present invention is the ability to use artificial intelligence and machine learning to monitor the primary user's behavior and then modify the methods of the present invention to better serve as a digital assistant. To accomplish this, the present invention provides a behavioral model for the arbitrary account. The behavioral model is a digital representation of the primary user's behavior that includes, but is not limited to, past behavior, colleague contact information, child accounts, personal preferences, inter-account interactions, calendar events, and internet activity. This behavioral model is managed by the remote server. This sub-process begins by outputting a set of user preferences for the arbitrary account with the remote server based on the behavioral model. The set of user preferences is created by performing statistical analysis of the behavioral model to determine how the primary user tends to act in a given situation. The sub-process continues by extrapolating a set of user suggestions from the set of preferences with the remote server. The present invention makes use of the primary user's known preferences to generate suggestions that will improve the primary user's efficiency and quality of life. For example, the primary user may prefer to eat tacos for lunch on Tuesdays. The method of the present invention will recognize this preference and suggest nearby Mexican restaurants during lunchtime. The sub-process concludes by notifying the arbitrary account with the set of suggestions through the corresponding PC device. As a result, the primary user becomes more informed about better ways to live.

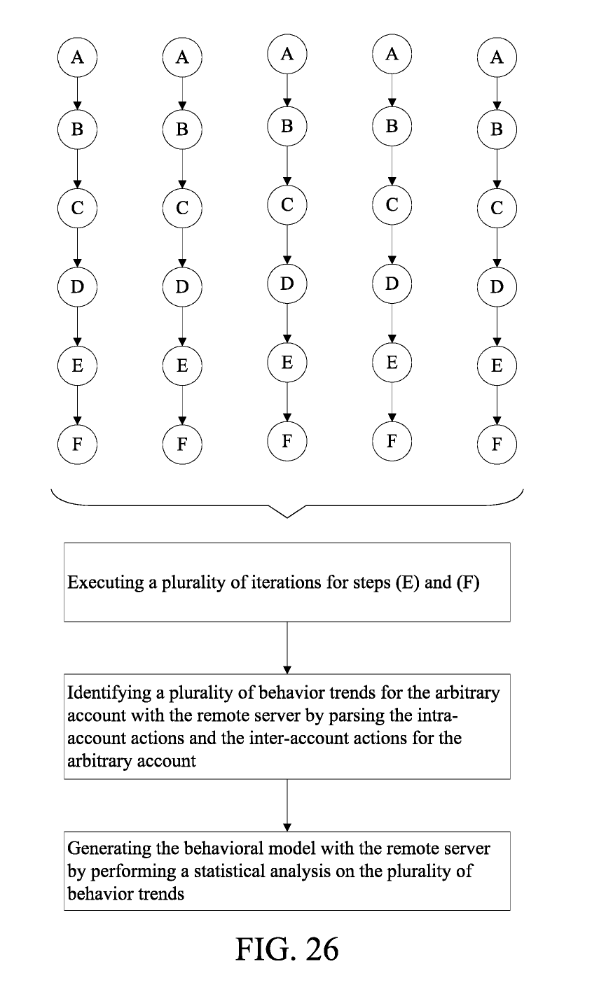

As can be seen in FIG. 26, a sub-process of the digital assistant feature includes an iterative learning system that further refines the behavioral model by determining behavioral trends. This sub-process begins by executing a plurality of iterations for Step E and Step F. Through this repetition, the digital assistant is able to form informed trends of the primary user's behavior. The sub-process continues by tracking intra-account actions and inter-account actions for the arbitrary account with the remote server during each of the plurality of iterations of Step E and Step F. This enables the behavioral model to further refine it's understanding of how the primary user acts. The sub-process continues by identifying a plurality of behavior trends for the arbitrary account with the remote server by parsing the intra-account actions and the inter-account actions for the arbitrary account. The plurality of behavioral trends enables the method of the present invention to identify routines in the primary user's behavior. Finally, the sub-process concludes by generating the behavioral model with the remote server by performing a statistical analysis on the plurality of behavior trends. Thus, the method of the present invention is able to create an accurate digital representation of the primary user's behavior.

Although the invention has been explained in relation to its preferred embodiment, it is to be understood that many other possible modifications and variations can be made without departing from the spirit and scope of the invention as hereinafter claimed.

What is claimed is:

1. A method of managing user contacts and associations between the user contacts, the method comprises the steps of:
(A) providing a plurality of parent accounts managed by at least one remote server, wherein each of the plurality of parent accounts includes a parent profile and is associated with a corresponding personal computing (PC) device;
(B) receiving at least one colleague contact information from an arbitrary account through the corresponding PC device, wherein the arbitrary account is any one of the plurality of parent accounts;
(C) comparing the colleague contact information to the parent profile for each of the plurality of parent accounts with the remote server in order to identify a matching account from the plurality of parent accounts;
(D) permitting communication between the arbitrary account and the matching account with the remote server, if the remote server does identify the matching account during step (C);
(E) prompting the arbitrary account to select from the plurality of life-management processes through the corresponding PC device; and
(F) executing a desired process for the arbitrary account with the remote server, if the arbitrary account selects the desired process from the plurality of life-management processes in step (E).

2. The method of managing user contacts and associations between the user contacts, the method as claimed in claim 1 comprises the step of:
sending a join notification to the colleague contact information with the remote server, if the remote server does not identify the matching account during step (C).

3. The method of managing user contacts and associations between the user contacts, the method as claimed in claim 1 comprises the steps of:
providing a join notification associated with the arbitrary account;
receiving response information to the join notification with the remote server;
generating a new parent account from the response information with the remote server;
appending the new parent account into the plurality of parent accounts with the remote server; and
permitting communication between the arbitrary account and the new parent account with the remote server.

4. The method of managing user contacts and associations between the user contacts, the method as claimed in claim 1 comprises the steps of:
wherein the desired process is a hierarchal account-relationship process;
receiving a child-creation request from the arbitrary account through the corresponding PC device;
generating at least one child account for the arbitrary account based on the child-creation request with the remote server;
prompting the arbitrary account to setup internal permission filters for the child account through the corresponding PC device; and
restricting communication between the arbitrary account and the child account based on the internal permission filters with the remote server.

5. The method of managing user contacts and associations between the user contacts, the method as claimed in claim 4 comprises the steps of:
prompting the arbitrary account to setup external permission filters for the child account through the corresponding PC device; and
restricting communication between the matching account and the child account based on the external permission filters with the remote server.

6. The method of managing user contacts and associations between the user contacts, the method as claimed in claim 4 comprises the steps of:
providing at least one dependent account for the matching account;
prompting the arbitrary account to setup external permission filters for the child account through the corresponding PC device; and
restricting communication between the dependent account and the child account based on the external permission filters with the remote server.

7. The method of managing user contacts and associations between the user contacts, the method as claimed in claim 1 comprises the steps of:
wherein the desired process is an asset management process;
(G) receiving an asset-recording request from the arbitrary account through the corresponding PC device;
(H) generating an asset log entry for the arbitrary account based on the asset-recording request with the remote server; and
(I) compiling a plurality of asset log entries for the arbitrary account with the remote server by executing a plurality of iterations for steps (G) and (H).

8. The method of managing user contacts and associations between the user contacts, the method as claimed in claim 7 comprises the steps of:
receiving new asset information for a specific entry from the plurality of asset log entries through the corresponding PC device; and
updating the specific entry with the new asset information with the remote server.

9. The method of managing user contacts and associations between the user contacts, the method as claimed in claim 7 comprises the steps of:
receiving an asset search query from the arbitrary account through the corresponding PC device;
comparing the asset search query to each of the plurality of asset log entries with the remote server in order to identify at least one matching entry from the plurality of asset log entries; and
displaying the matching entry to the arbitrary account with the corresponding PC device.

10. The method of managing user contacts and associations between the user contacts, the method as claimed in claim 1 comprises the steps of:
wherein the desired process is contacts intercommunication process;
(J) prompting the arbitrary account to designate a message content for the matching account through the corresponding PC device; and
(K) sending the message content to the matching account from the remote server.

11. The method of managing user contacts and associations between the user contacts, the method as claimed in claim 10 comprises the steps of:
prompting the arbitrary account to enter a personalized content through the corresponding PC device; and
designating the personalized content as the message content with the remote server during step (J).

12. The method of managing user contacts and associations between the user contacts, the method as claimed in claim 10 comprises the steps of:
prompting the arbitrary account to select a sharable portion through the corresponding PC device, wherein the sharable portion is from the parent profile of the arbitrary account; and
designating the sharable portion as the message content with the remote server during step (J).

13. The method of managing user contacts and associations between the user contacts, the method as claimed in claim 10 comprises the steps of:
providing at least one child account for the arbitrary account managed by the remote server, wherein the child account includes a child profile and is also associated with a corresponding PC device;
prompting the child account to enter a personalized content through the corresponding PC device;
sending the personalized content to the arbitrary account through the corresponding PC device; and
designating the personalized content as the message content with the remote server during step (J).

14. The method of managing user contacts and associations between the user contacts, the method as claimed in claim 10 comprises the steps of:
providing at least one child account for the arbitrary account managed by the remote server, wherein the child account includes a child profile and is also associated with a corresponding PC device;
prompting the child account to select a sharable portion through the corresponding PC device, wherein the sharable portion is from the child profile;
sending the sharable portion to the arbitrary account through the corresponding PC device; and
designating the sharable portion as the message content with the remote server during step (J).

15. The method of managing user contacts and associations between the user contacts, the method as claimed in claim 10 comprises the steps of:
providing the at least one matching account as a plurality of matching accounts;
prompting the arbitrary account to select a set of desired accounts from the plurality of matching accounts through the corresponding PC device before step (K); and
sending the message content to each account within the set of desired accounts from the remote server during step (K).

16. The method of managing user contacts and associations between the user contacts, the method as claimed in claim 1 comprises the steps of:
wherein the desired process is contacts intercommunication process;
(L) providing at least one dependent account for the matching account managed by the remote server;
(M) prompting the arbitrary account to designate a message content for the dependent account through the corresponding PC device; and
(N) sending the message content to the dependent account from the remote server.

17. The method of managing user contacts and associations between the user contacts, the method as claimed in claim 16 comprises the steps of:
prompting the arbitrary account to enter a personalized content through the corresponding PC device; and
designating the personalized content as the message content with the remote server during step (M).

18. The method of managing user contacts and associations between the user contacts, the method as claimed in claim 16 comprises the steps of:
prompting the arbitrary account to select a sharable portion through the corresponding PC device, wherein the sharable portion is from the parent profile of the arbitrary account; and
designating the sharable portion as the message content with the remote server during step (M).

19. The method of managing user contacts and associations between the user contacts, the method as claimed in claim 16 comprises the steps of:
providing at least one child account for the arbitrary account managed by the remote server, wherein the child account includes a child profile and is also associated with a corresponding PC device;
prompting the child account to enter a personalized content through the corresponding PC device;
sending the personalized content to the arbitrary account through the corresponding PC device; and
designating the personalized content as the message content with the remote server during step (M).

20. The method of managing user contacts and associations between the user contacts, the method as claimed in claim 16 comprises the steps of:
providing at least one child account for the arbitrary account managed by the remote server, wherein the child account includes a child profile and is also associated with a corresponding PC device;
prompting the child account to select a sharable portion through the corresponding PC device, wherein the sharable portion is from the child profile;
sending the sharable portion to the arbitrary account through the corresponding PC device; and
designating the sharable portion as the message content with the remote server during step (M).

21. The method of managing user contacts and associations between the user contacts, the method as claimed in claim 16 comprises the steps of:
providing the at least one dependent account as a plurality of dependent accounts;
prompting the arbitrary account to select a set of desired accounts from the plurality of dependent accounts through the corresponding PC device before step (N); and
sending the message content to each within the set of desired accounts from the remote server during step (N).

22. The method of managing user contacts and associations between the user contacts, the method as claimed in claim 1 comprises the steps of:
wherein the desired process is an adaptive calendar management process;
(O) providing a scheduling calendar for the arbitrary account, wherein the scheduling calendar is managed by the remote server;
(P) prompting the arbitrary account to create an appointment log entry through the corresponding PC device;
(Q) chronologically integrating the appointment log entry into the scheduling calendar with the remote server;
(R) compiling a plurality of appointment log entries for the arbitrary account with the remote server by executing a plurality of iterations for steps (P) and (Q); and
(S) prompting the arbitrary account to navigate through the scheduling calendar through the corresponding PC device.

23. The method of managing user contacts and associations between the user contacts, the method as claimed in claim 22 comprises the steps of:
tracking a current date-and-time with the remote server;
comparing the current date-and-time to each of the plurality of appointment log entries with the remote server in order to identify approaching entries from the plurality of appointment log entries; and
notifying the arbitrary account of the approaching entries through the corresponding PC device.

24. The method of managing user contacts and associations between the user contacts, the method as claimed in claim 22 comprises the steps of:
prompting the arbitrary account to select a desired entry from the plurality of appointment log entries through the corresponding PC device; and
displaying detailed information for the desired entry to the arbitrary account through the corresponding PC device.

25. The method of managing user contacts and associations between the user contacts, the method as claimed in claim 1 comprises the steps of:
providing a behavioral model for the arbitrary account, wherein the behavioral model is managed by the remote server;
outputting a set of user preferences for the arbitrary account with the remote server based on the behavioral model;
extrapolating a set of user suggestions from the set of user preferences with the remote server; and
notifying the arbitrary account with the set of user suggestions through the corresponding PC device.

26. The method of managing user contacts and associations between the user contacts, the method as claimed in claim 25 comprises the steps of:
executing a plurality of iterations for steps (E) and (F);
tracking intra-account actions and inter-account actions for the arbitrary account with the remote server during each of the plurality of iterations of steps (E) and (F);
identifying a plurality of behavior trends for the arbitrary account with the remote server by parsing the intra-account actions and the inter-account actions for the arbitrary account; and
generating the behavioral model with the remote server by performing a statistical analysis on the plurality of behavior trends.
